(19) United States
(12) Patent Application Publication
(10) Pub. No.: US 2024/0354453 A1
(43) Pub. Date: Oct. 24, 2024

(54) METADATA PREDICTION FOR PRODUCT DESIGN

(71) Applicant: Siemens Industry Software Inc., Plano, TX (US)

(72) Inventors: Gerald P. Suiter II, Madison, AL (US); Wei Wei, Longmont, CO (US); Dariusz Rozwadowski, Gliwice (PL)

(73) Assignee: Siemens Industry Software Inc., Plano, TX (US)

(21) Appl. No.: 18/682,171

(22) PCT Filed: Aug. 17, 2021
(86) PCT No.: PCT/US2021/046248

§ 371 Date: Feb. 8, 2024

(51) Int. Cl. G06F 30/10; G06F 30/27; G06F 111/04

(52) U.S. Cl. CPC G06F 30/10; G06F 30/27; G06F 2111/04

(57) ABSTRACT

This application discloses a computing system (400) to generate a product model (409) that describes attributes of a product including an electronic system (401). The computing system (400) can implement a machine-learning algorithm having been trained with metadata populated in previously generated product models for different electronic systems, which can determine one or more sets of metadata capable of being correlated to the electronic system included in the product model based on the attributes of the electronic system described in the product model. The sets of metadata can correspond to different design constraints in the product model associated with electrical connectivity for the electronic system and their corresponding parameter values. The computing system can populate at least one of the sets of metadata into the product model to correlate with the electronic system.

### TECHNICAL FIELD

This application is generally related to electronic design automation and, more specifically, to metadata prediction for product design.

### BACKGROUND

The development of electronic devices with printed circuit boards typically involves many steps, known as a design flow. This design flow typically starts with a specification for a new circuit to be implemented with a printed circuit board. The specification of the new circuit can be transformed into a circuit design, such as a netlist, for example, by a schematic capture tool or by synthesizing a logical circuit design, sometimes referred to as a register transfer level (RTL) description of the circuit. The netlist, commonly specified in an Electronic Digital Exchange Format (EDIF), can describe nets or connectivity between various devices or instances in the circuit design.

The design flow continues by verifying functionality of the circuit design, for example, by simulating or emulating the circuit design and verifying that the results of the simulation or emulation correspond with an expected output from the circuit design. The functionality also can be verified by statically checking the circuit design for various attributes that may be problematic during operation of an electronic device built utilizing the circuit design.

Once the circuit design has been functionally verified, the design flow continues to design layout and routing, which includes placing and interconnecting various components or parts into a layout representation of a printed circuit board. This procedure can be implemented in many different ways, but typically, through the use of a layout tool, which can present a graphical view of the printed circuit board and allow a designer to drag or place parts from a library onto the layout representation of the printed circuit board. The layout tool can validate the electronic device and perform various design rule checks on placed parts to ensure that the electronic device can be effectively built.

Since many electronic devices made on printed circuit boards will be included within a product, the layout of the printed circuit board may be constrained to ensure the product can be designed and manufactured. Designers can create a product definition having attributes, such as length, delay or the like, and design constraints, for example, which describe electrical interconnectivity between components in the electronic device. Typically, the designers manually enter the product definition into a spreadsheet-based interface of a printed circuit board layout tool for use during the layout and verification of the printed circuit board. The creation of the product definition and population of the definition with metadata, such as the design constraints, can be a difficult, time-consuming, and error-prone task of manually reviewing component datasheets and generating design constraints from pertinent information in the datasheets, as it usually becomes dependent on engineering expertise to accomplish without introducing design defects during the layout of the printed circuit board.

### SUMMARY

This application discloses a computing system to generate a product model that describes attributes of a product including an electronic system. The computing system can implement a machine-learning algorithm having been trained with metadata populated in previously generated product models for different electronic systems, which can determine one or more sets of metadata capable of being correlated to the electronic system included in the product model based on the attributes of the electronic system described in the product model. The sets of metadata can correspond to different design constraints in the product model associated with electrical connectivity for the electronic system and their corresponding parameter values. The computing system can populate at least one of the sets of metadata into the product model to correlate with the electronic system. Embodiments will be described below in greater detail.

### DESCRIPTION OF THE DRAWINGS

FIG. 1 illustrates an example system implementing a product design environment according to various embodiments.

FIGS. 2 and 3 illustrate an example of a computer system of the type that may be used to implement various embodiments.

FIG. 4 illustrates an example of a product design system with metadata prediction according to various embodiments.

FIG. 5 illustrates an example of a printed circuit board layout tool with product model generation utilizing metadata prediction according to various embodiments.

FIG. 6 illustrates an example flowchart for product model generation utilizing metadata prediction according to various embodiments.

### DETAILED DESCRIPTION

### Illustrative Operating Environment

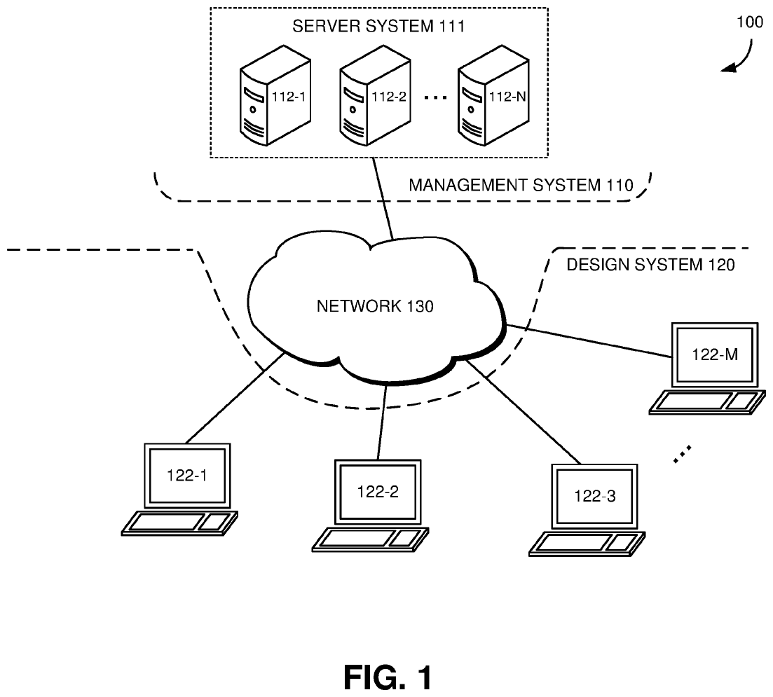

FIG. 1 illustrates an example system 100 implementing a product design environment according to various embodiments. Referring to FIG. 1, the system 100 includes a server-side, for example, a management system 110, and a client-side, for example, a design system 120, which can communicate with each other over a network 130. The server-side can include the server system 111 to retain metadata used in the design of electronic or electromechanical products and to implement the metadata prediction for the client-side of the system 100. In some embodiments, the server system 111 can include one or more servers 112-1 to 112-N or other processing devices capable of implementing the metadata prediction across the product design environment for the design system 120.

The client-side, for example, a design system 120, can include multiple client devices 122-1 to 122-M, which can communicate with the server system 111 directly or through a network 130. In some embodiments, each of the client devices 122-1 to 122-M can implement at least one electronic design automation tool, such as a printed circuit board layout tool and include a product design interface (not shown) to communicate with the server system 111. The client devices 122-1 to 122-M can be computers, laptops, workstations, tablets, handsets, or other processing devices capable of communicating with the server system 111 directly or over the network 130. The network 130 can include one or more packet-switched networks, one or more circuit-switched networks, a combination of both, or the like, which can exchange communication between the server-side and the client-side over wired, wireless, cellular, or any other transmission medium.

The execution of various electronic or electromechanical design automation processes, such as in client devices 122-1 to 122-M, or the metadata prediction for those processes, such as in server system 111, according to embodiments of may be implemented using computer-executable software instructions executed by one or more programmable computing devices. Because these embodiments may be implemented using software instructions, the components and operation of a programmable computer system on which various embodiments may be employed will first be described. Further, because of the complexity of some electronic design automation processes and the large size of many circuit designs, various electronic design automation tools are configured to operate on a computing system capable of simultaneously running multiple processing threads.

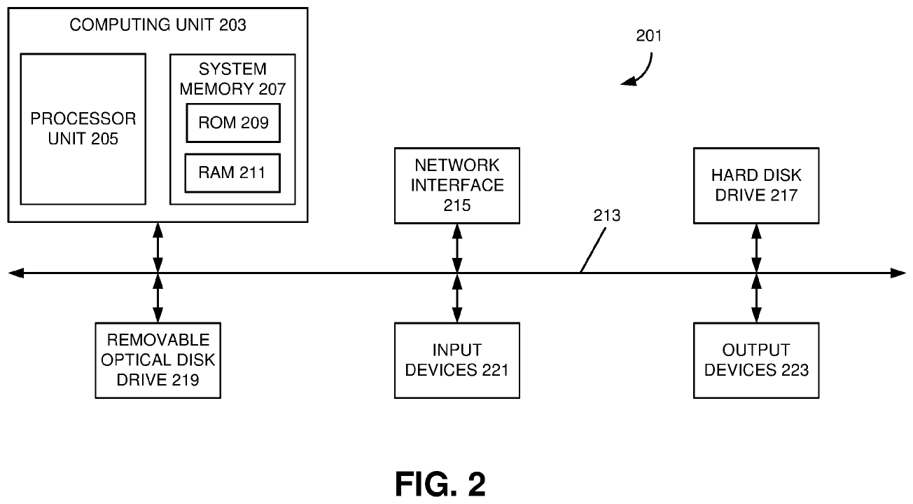

Various examples may be implemented through the execution of software instructions by a computing device 201, such as a programmable computer. Accordingly, FIG. 2 shows an illustrative example of a computing device 201. As seen in this figure, the computing device 201 includes a computing unit 203 with a processor unit 205 and a system memory 207. The processor unit 205 may be any type of programmable electronic device for executing software instructions, but will conventionally be a microprocessor. The system memory 207 may include both a read-only memory (ROM) 209 and a random access memory (RAM) 211. As will be appreciated by those of ordinary skill in the art, both the read-only memory (ROM) 209 and the random access memory (RAM) 211 may store software instructions for execution by the processor unit 205.

The processor unit 205 and the system memory 207 are connected, either directly or indirectly, through a bus 213 or alternate communication structure, to one or more peripheral devices 215-223. For example, the processor unit 205 or the system memory 207 may be directly or indirectly connected to one or more additional memory storage devices, such as a hard disk drive 217, which can be magnetic and/or removable, a removable optical disk drive 219, and/or a flash memory card. The processor unit 205 and the system memory 207 also may be directly or indirectly connected to one or more input devices 221 and one or more output devices 223. The input devices 221 may include, for example, a keyboard, a pointing device (such as a mouse, touchpad, stylus, trackball, or joystick), a scanner, a camera, and a microphone. The output devices 223 may include, for example, a monitor display, a printer and speakers. With various examples of the computing device 201, one or more of the peripheral devices 215-223 may be internally housed with the computing unit 203. Alternately, one or more of the peripheral devices 215-223 may be external to the housing for the computing unit 203 and connected to the bus 213 through, for example, a Universal Serial Bus (USB) connection.

With some implementations, the computing unit 203 may be directly or indirectly connected to a network interface 215 for communicating with other devices making up a network. The network interface 215 can translate data and control signals from the computing unit 203 into network messages according to one or more communication protocols, such as the transmission control protocol (TCP) and the Internet protocol (IP). Also, the network interface 215 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 201 is illustrated as an example only, and it not intended to be limiting. Various embodiments may be implemented using one or more computing devices that include the components of the computing device 201 illustrated in FIG. 2, which include only a subset of the components illustrated in FIG. 2, or which include an alternate combination of components, including components that are not shown in FIG. 2. For example, various embodiments may be implemented using a multi-processor computer, a plurality of single and/or multiprocessor computers arranged into a network, or some combination of both.

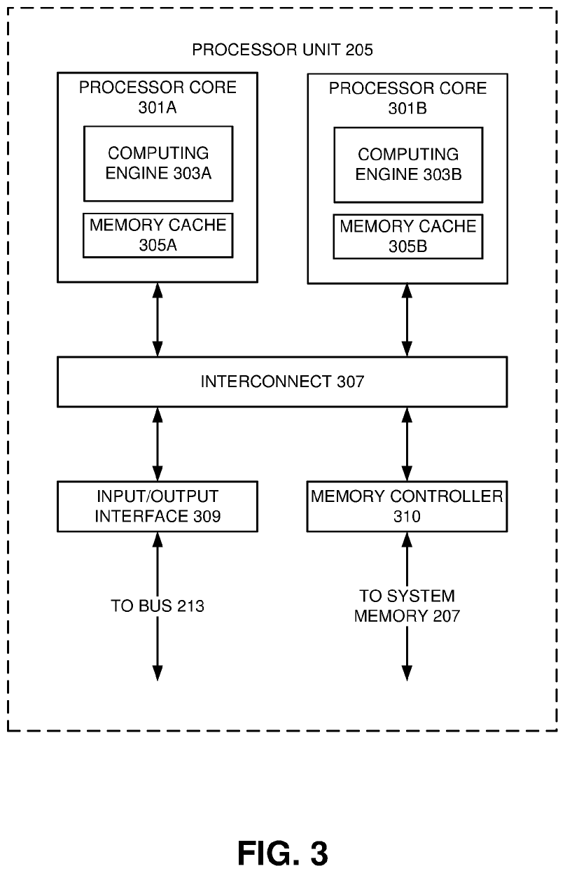

With some implementations, the processor unit 205 can have more than one processor core. Accordingly, FIG. 3 illustrates an example of a multi-core processor unit 205 that may be employed with various embodiments. As seen in this figure, the processor unit 205 includes a plurality of processor cores 301A and 301B. Each processor core 301A and 301B includes a computing engine 303A and 303B, respectively, and a memory cache 305A and 305B, respectively. As known to those of ordinary skill in the art, a computing engine 303A and 303B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 303A and 303B may then use its corresponding memory cache 305A and 305B, respectively, to quickly store and retrieve data and/or instructions for execution.

Each processor core 301A and 301B is connected to an interconnect 307. The particular construction of the interconnect 307 may vary depending upon the architecture of the processor unit 205. With some processor cores 301A and 301B, such as the Cell microprocessor created by Sony Corporation, Toshiba Corporation and IBM Corporation, the interconnect 307 may be implemented as an interconnect bus. With other processor units 301A and 301B, however, such as the Opteron™ and Athlon™ dual-core processors available from Advanced Micro Devices of Sunnyvale, California, the interconnect 307 may be implemented as a system request interface device. In any case, the processor cores 301A and 301B communicate through the interconnect 307 with an input/output interface 309 and a memory controller 310. The input/output interface 309 provides a communication interface to the bus 213. Similarly, the memory controller 310 controls the exchange of information to the system memory 207. With some implementations, the processor unit 205 may include additional components, such as a high-level cache memory accessible shared by the processor cores 301A and 301B. It also should be appreciated that the description of the computer network illustrated in FIG. 2 and FIG. 3 is provided as an example only, and is not intended to suggest any limitation as to the scope of use or functionality of alternate embodiments.

Product Design System with Metadata Prediction

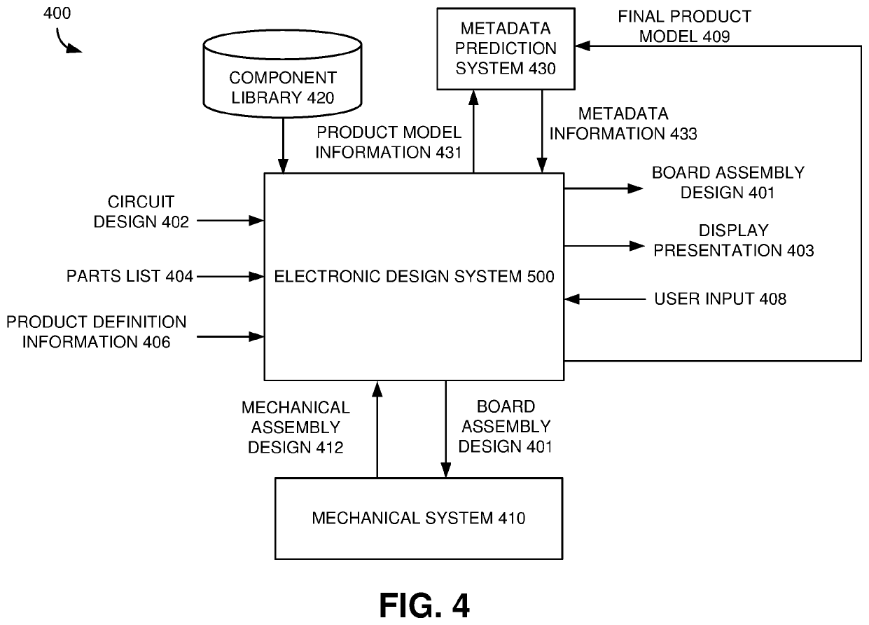

FIG. 4 illustrates an example of a product design system 400 with a metadata prediction according to various embodiments. Referring to FIG. 4, the design system 400 can be a distributed design environment, which allows different aspects of product design to be performed by different communicating tools or systems. For example, the design system 400 can include a mechanical system 410 to develop a mechanical assembly design 412 for a product, and an electronic design system 500 to develop a board assembly design 401 for an electronic system, which can be included in the product.

The mechanical assembly design 412 can describe various physical design elements associated with the product, such as a design for a housing of the product. In some examples, the design for the housing can include locations and dimensions of electronic system(s) and physical interfaces, such as a display device, a touchscreen, an image capture device, input/output devices, electrical ports, audio devices, or the like. The mechanical assembly design 412 also can describe physical mounting information for the physical interfaces and electronic system(s), describe physical connectivity of the physical interfaces and electronic system(s) to each other and to the housing of the product, describe a presence of mechanical heat dissipation devices in the product, or the like.

The board assembly design 401 can describe the electronic system for the product in terms of various components placed and interconnected on a representation of a printed circuit board. The electronic design system 500 can provide a design environment to layout a circuit design 402, which can describe the electronic system as sets of interconnected components, into the board assembly design 401 by utilizing a parts list 404 to place parts or components from a component library 420 onto the representation of printed circuit board. The electronic design system 500 can receive the circuit design 402, such as a netlist, which can describe components in an electronic system and the connectivity of those components to each other. In some embodiments, the netlist can be generated by a schematic capture tool or by synthesizing a logical circuit design, sometimes referred to as a register transfer level (RTL) description of the circuit. The netlist can be specified in an Electronic Digital Exchange Format (EDIF), which can describe nets or connectivity between various components or instances in the circuit design 402. The electronic design system 500 also can receive the parts list 404 including multiple parts that can correspond to the components described in the circuit design 402. Although FIG. 4 shows the electronic design system 500 receiving the circuit design 402 and the parts list 404, in some embodiments, the electronic design system 500 can generate the circuit design 402 and/or parts list 404 internally.

The mechanical system 410 and the electronic design system 500 can exchange design information with each other. For example, the electronic design system 500 can output the board assembly design 401 to the mechanical system 410 or a memory system (not shown) directly or indirectly accessible by the mechanical system 410. Likewise, the mechanical system 410 can output the mechanical assembly design 412 to the electronic design system 500 or a memory system (not shown) directly or indirectly accessible by the electronic design system 500. The mechanical system 410 and the electronic design system 500 can share their respective designs with each other at any point during the design process, for example, through an exchange of design files in the form of STEP (Standard for the Exchange of Product model data) and/or SAT (Standard ACIS Text) files. The format of a STEP file, in some embodiments, can be defined in (International Organization for Standardization) ISO 10303-21, entitled “Industrial automation systems and integration—Product data representation and exchange—Part 21: Implementation methods: Clear text encoding of the exchange structure.”

The electronic design system 500, for example, prior to the generation of the board assembly design 401, can receive product definition information 406, which can include attributes of the electronic system. The electronic design system 500 can generate a product model for the electronic system based, at least in part, on the product definition information 406. The product model for the electronic system can include the attributes of the electronic system, for example, from the product definition information 406, design constraints that can describe the electrical connectivity in the electronic system, and properties of the electronic system corresponding to combinations of design constraints used together. In some embodiments, the design constraints in the product model can correspond to mechanical constraints and/or electrical constraints.

The electronic design system 500 can output a display presentation 403 that, when displayed by a display device, can provide a user interface to the design environment, allowing the electronic design system 500 to present the product model for the electronic system. While the electronic design system 500 can populate the product model with design constraints, properties, and corresponding parameter values in response to user input 408, the electronic design system 500 also can generate the product model for the electronic system based, at least in part, on metadata information 433, for example, including predicted design constraints, properties, and/or parameter values, from a metadata prediction system 430 in the design system 400.

The electronic design system 500, in some embodiments, can communicate product model information 431 to the metadata prediction system 430, which can include a current version of the product model under development, attributes of the electronic system and/or the mechanical assembly design 412, include any user input 408 corresponding to design constraints, properties, parameter values, or the like. The metadata prediction system 430 can utilize previously developed product models and the product model information 431 to predict one or more design constraints, properties, and parameter values for the electronic design system 500 to include in the product model for the electronic system associated with the product definition information 406.

The metadata prediction system 430, in some embodiments, can store the previously developed product models for electronic devices or systems, which can be accessed or referenced based on the product model information 431. The metadata prediction system 430 also may implement a machine-learning algorithm having been trained with the previously developed product models. In some embodiments, the metadata prediction system 430 can be implemented within the electronic design system 500, within a server system, such as server system 111 described above with reference to FIG. 1, or in any other computing system capable of communicating with the electronic design system 500.

The metadata prediction system 430 can generate metadata information 433 based on the predicted design constraints, properties, and parameter values, which the electronic design system 500 can utilize during development of the product model for the electronic system. In some embodiments, the electronic design system 500 can utilize the metadata information 433 to set one or more design constraints, properties, and/or parameter values in the product model. The electronic design system 500 also can include at least a portion of the metadata information 433 in the display presentation 403 and then receive user input 408, for example, based on the display presentation 403 including the metadata information 433, for example, as suggested design constraints, properties, and parameter values, which can prompt the electronic design system 500 to perform various updates to the product model for the electronic system. This interactive development process can continue until a final product model 409 for the electronic system described in the product definition information 406 has been generated.

The electronic design system 500 can utilize the final product model 409 for development of the electronic system, verification of the electronic system, and to further train the metadata prediction system 430. In some embodiments, the electronic design system 500 can provide the final product model 409 to the metadata prediction system 430 for use in the development of any subsequent product models for electronic devices or systems. For example, when the metadata prediction system 430 includes a machine-learning algorithm, the metadata prediction system 430 can utilize the design constraints, properties, and associated parameters values to train the machine-learning algorithm for the prediction of the metadata information 433 for development of any subsequent product models. Embodiments of the product model generation utilizing metadata prediction will be described below in greater detail.

After the final product model 409 has been generated, the electronic design system 500 can output another version of the display presentation 403 that, when displayed by a display device, can provide a user interface to the design environment, allowing the electronic design system 500 to generate the board assembly design 401 in response to user input 408. The display presentation 403, in this embodiment, can include a graphical display window including at least one representation of the board assembly design 401 and include various tools or embedded functionality that can allow placement of parts or components from the parts list 404 into the board assembly design 401.

The board assembly design 401 initially can represent a blank print circuit board, for example, having dimensions corresponding to one or more of the mechanical constraints gleaned from the mechanical assembly design 412. The electronic design system 500 can receive user input 408, for example, based on the display presentation 403, which can prompt the electronic design system 500 to perform various updates to the board assembly design 401 based on the circuit design 402, such as place parts selected or composited from the parts list 404 in the board assembly design 401, route traces between the placed parts or composite parts, or the like. In some embodiments, the electronic design system 500, in response to a user selection of a part from the parts list 404, can access the component library 420 to identify a component model corresponding to the selected part capable of being placed in the representation of the board assembly design 401.

The electronic design system 500 can perform various design rule checks on the board assembly design 401, for example, based on the previously developed product model, to determine whether the updates in the board assembly design 401 violate any design rules. For example, the electronic design system 500 can review locations and characteristics of component models placed in the representation of the printed circuit board to determine whether the component models, as placed, conform to the design rules. The electronic design system 500 can update the display presentation 403 based on the user input 408, for example, to illustrate the placement of a selected part or route of a trace line and highlight conformance or lack thereof with at least one of the design rules, which can be displayed or presented by the display device. This interactive design process can continue until layout of the circuit design 402 has been completed and thus the electronic design system 500 has generated the board assembly design 401 congruent with the mechanical assembly design 412. Since the mechanical system 410 and the electronic design system 500 can exchange their respective designs with each other at any time during the design process, any changes in one design that conflict with another design can be caught and rectified earlier in the process.

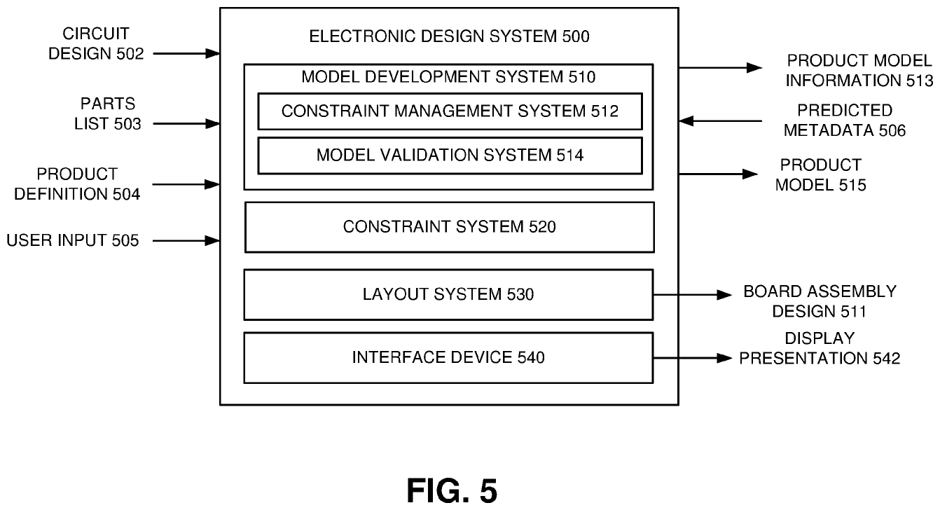

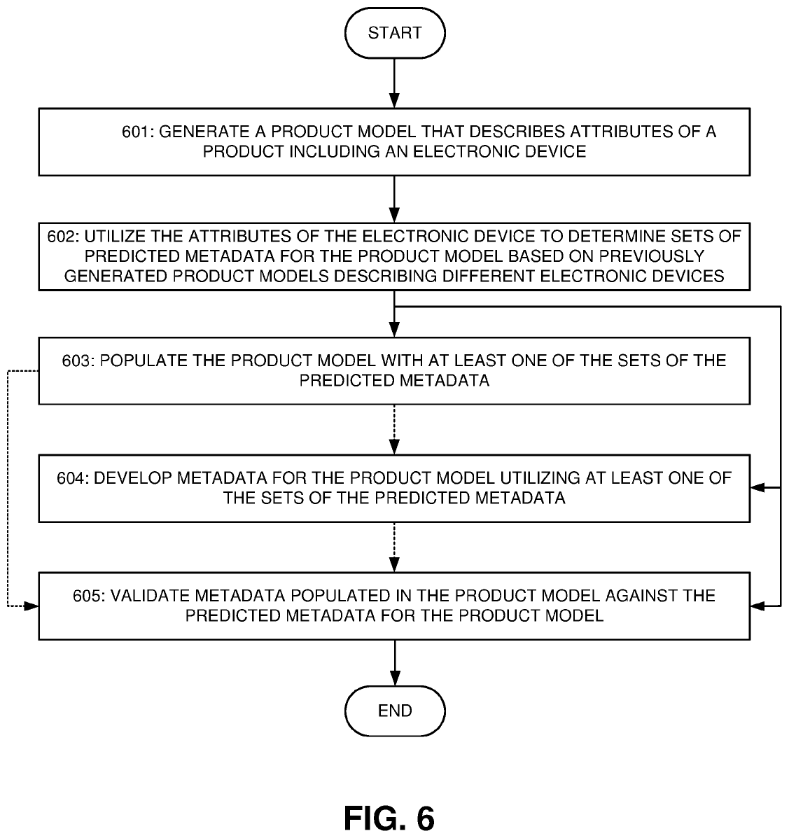

FIG. 5 illustrates an example of an electronic design system 500 with product model generation utilizing metadata prediction according to various embodiments. FIG. 6 illustrates an example flowchart for product model generation utilizing metadata prediction according to various embodiments. Referring to FIGS. 5 and 6, the electronic design system 500 can include a model development system 510 that, in a block 601 of FIG. 6, can generate a product model 515 of an electronic system based, at least in part, on a product definition 504 having attributes of the electronic system. The product model 515 for the electronic system can include one or more design constraints that can describe the electrical connectivity in the electronic system, and properties of the electronic system corresponding to combinations of design constraints used together. In some embodiments, the design constraints in the product model 515 can correspond to mechanical constraints and/or electrical constraints.

The model development system 510 can include a constraint management system 512 to facilitate the population of the product model 515 with metadata, such as the design constraints, properties, and parameter values thereof. The constraint management system 512, in a block 602 of FIG. 6, can utilize the attributes of the electronic system to determine sets of predicted metadata 506 for the product model 515 based on previously generated product models describing different electronic systems.

The constraint management system 512 can provide product model information 513, which can include the product model 515 currently being developed, one or more attributes of the electronic system from the product definition 504, or the like, to a metadata prediction system for generation of predicted metadata 506 for the product model 515. In some embodiments, the constraint management system 512 can identify the attributes of the electronic system in the product from the product definition 504, such as a product layer stack, components utilized in the electronic system, net types, or the like. The model development system 510 can generate the product model information 513 based on the identified attributes of the electronic system. As will be discussed below in greater detail, the product model information 513 also can include additional metadata information, such as selected design constraints, selected properties, and any parameter values associated with the selected design constraints and/or properties.

The electronic design system 500 can transmit the product model information 513 to the metadata prediction system for use in generating the predicted metadata 506. In some embodiments, the metadata prediction system can be a machine-learning algorithm capable of utilizing the attributes of the electronic system and any additional metadata to predict metadata for the product model 515. The electronic design system 500 can receive predicted metadata 506 from the metadata prediction system, which can include predicted design constraints for the product model 515, predicted properties for the product model 515, and predicted parameter values for the design constraints and/or properties.

The constraint management system 512, in a block 603 of FIG. 6, can populate the product model 515 with metadata from at least one of the sets of the predicted metadata 506. In some embodiments, the population of the product model 515 with the predicted metadata 506 can be utilized by the model development system 510 as a technique to set initial design constraints, properties, and associated parameter values for the product model 515 as opposed to leaving metadata of the product model 515 blank initially or populated with a default set of metadata.

The constraint management system 512, in a block 604 of FIG. 6, can develop metadata for the product model utilizing the predicted metadata 506. In some embodiments, the constraint management system 512 can utilize the predicted metadata 506 to identify possible design constraints to set for the product model 515, possible combinations of design constraints to include in the product model 515, and possible parameter values to set for the design constraints and properties.

The constraint management system 512 can utilize the predicted metadata 506 in coordination with an interface device 540 of the electronic design system 500 to develop metadata for the product model 515. The interface device 540 can output a display presentation 542 that, when displayed by a display device, can provide a user interface for the entry of metadata in the product model 515. The constraint management system 512 can prompt the interface device 540 to present at least a portion of the predicted metadata 506 in the display presentation 542, and the electronic design system 500 can receive user input 505 based on the display presentation 542.

In some examples, when the constraint management system 512 prompts the interface device 540 to present, in the display presentation 542, a set of possible design constraints that can be added to the product model 515, the electronic design system 500 can receive user input 505 corresponding to a selection of one or more of the design constraints. The constraint management system 512, based on the user input 505, can prompt the interface device 540 to present, in the display presentation 542, predicted parameter values associated with the selected design constraint based on the predicted metadata 506. In some embodiments, the parameter values in the predicted metadata 506 can be presented in a dropdown menu or list, which can be arranged in an order of how probable the predicted parameter values are to be an accurate parameter value for the selected design constraint. The constraint management system 512 can determine how to present the parameter values in the predicted metadata 506 during the population of the selected design constraint based on the user input 505.

When the user input 505 prompts the constraint management system 512 to initiate entry of at least a portion of parameter value into the selected design constraint, the constraint management system 512 can filter the parameter values presented based on that user input 505. For example, when the user input 505 indicates a first digit of a parameter value corresponds to a “1”, the constraint management system 512 can filter the parameter values for the selected design constraint in the predicted metadata 506 to eliminate parameter values that do not begin with “1” and then redisplay the filtered parameter values from the predicted metadata 506. By adapting the presentation of the predicted metadata 506 based on the user input 505 during the entry of the metadata into the product model 515, the constraint management system 512 can provide real-time or near real-time metadata predictions based on input received regarding the product model 515.

The constraint management system 512, based on the user input 505, also can prompt the interface device 540 to present, in the display presentation 542, other design constraints or properties associated with the selected design constraint based on the predicted metadata 506. In some embodiments, the other design constraints or properties can be presented by highlighting or otherwise annunciating them in the set of possible design constraints, by adding the other design constraints or properties to the product model 515, possibly with predicted parameter values, or the like. When the user input 505 prompts the constraint management system 512 to initiate entry of at least a portion of parameter value into the selected design constraint, the constraint management system 512 can filter the predicted metadata 506 to identify any other design constraints or properties associated with the selected design constraint having the entered parameter value.

In some embodiments, the process of entering metadata can be iterative, such that each selection of metadata—whether it be of a constraint, property, parameter value—can prompt the constraint management system 512 to provide an additional prediction of the metadata for the product model 515. For example, after providing the predicted parameter values, a selection or entry of a parameter value for a design constraint based on user input 505 can be used to identify another prediction for metadata of the product model 515, such as an identification of another design constraint or parameter value to add to the product model 515. In some embodiments, the model development system 510, after each iteration, can update the product model information 513 to identify which metadata was populated in the product model 515 and receive a new version of the predicted metadata 506 from the metadata prediction system based on the updated product model information 513. The constraint management system 512 can utilize the new version of predicted metadata 506 in the display presentation 542 during the subsequent iterations.

The electronic design system 500 can include a model validation system 514 that, in a block 605 of FIG. 6, can validate metadata populated in the product model 515 against the predicted metadata 506 for the product model 515. The model validation system 514 can compare the predicted design constraints, properties, and parameter values in the predicted metadata 506 to the metadata populated in the product model 515 and present the differences identified in the comparison in a display presentation 542. For example, the model validation system 514 can identify a design constraint or a set of design constraints that were set in the product model 515, which were not included in the predicted metadata 506 or were not included together in the predicted metadata 506. In another example, the model validation system 514 can identify a design constraint or a set of design constraints that were not set in the product model 515, which were included in the predicted metadata 506. In yet another example, the model validation system 514 can identify parameter values for a design constraint or a property that were set in the product model 515, which were not previously utilized in a past product model or deviated from the values in the predicted metadata 506. The model variation system 514 can highlight or otherwise annunciate those design constraints, properties, or parameter values in the display presentation 542, which can allow for additional editing of the product model 515 via the interface device 540. In some embodiments, the validation process by the model validation system 514 can be performed after the product model 515 has been completely populated, for example, used as an error checking technique, while in other embodiments, the validation process by the model validation system 514 can be performed iteratively during the development of the metadata for the product model 515.

The electronic design system 500 can include a constraint system 520 to utilize the product model 515 to identify constraints that can limit or constrain layout of the circuit design 502 into the board assembly design 511. As discussed above, the product model 515 can include a description for the design of the product that includes board assembly design 511 developed by the printed circuit board layout tool 400. For example, the product model 515 can include information on a mechanical assembly of the product and the electronic system having multiple printed circuit boards included in the product. In some embodiments, the constraints can include a description of an enclosure that the board assembly design 511 is to fit into, locations and description of fasteners utilized to adhere a printed circuit board manufactured according to the board assembly design 511 to a housing described in the mechanical assembly design, presence and location of other mechanical devices, such as heat dissipation devices or physical interfaces in the mechanical assembly, or the like. The constraints can also include a description of components or wires placed other printed circuit boards in the product, which could have physical or electrical characteristics capable of limiting or constraining the layout of the circuit design 402 into the board assembly design 511.

The constraint system 520 can identify system-level design rules based on the electro-mechanical constraints identified or parsed from the product model 515. The system-level design rules can correspond to the electro-mechanical constraints, such that when board assembly design 511 violates a system-level design rule, the board assembly design 511 would be inconsistent with the product model 515 from which the electro-mechanical constraints were derived or identified. The electronic design system 500 can incorporate or associate the system-level design rules developed by the constraint system 520 with a master set of design rules utilized by the electronic design system 500 in design rule checks.

The electronic design system 500 can include a layout system 530 to generate a board assembly design 511 that corresponds to a layout of a circuit design 502 with parts from a parts list 503. The circuit design 502, such as a netlist, can describe components in an electronic system and the connectivity of those components to each other. In some embodiments, the netlist can be generated by a schematic capture tool or by synthesizing a logical circuit design, sometimes referred to as a register transfer level (RTL) description of the circuit. The netlist can be specified in an Electronic Digital Exchange Format (EDIF), which can describe nets or connectivity between various components or instances in the circuit design 502. The parts list 503 can include multiple parts that can correspond to the components described in the circuit design 502. Although FIG. 5 shows the electronic design system 500 receiving the circuit design 502 and the parts list 503, in some embodiments, the electronic design system 500 can generate the circuit design 502 and/or parts list 503 internally.

The interface device 540 can output another version of the display presentation 542 that, when displayed by a display device, can provide a user interface to the design environment. The display presentation 542 can include a graphical display window including at least one layout representation of the board assembly design 511 from the layout system 530 and include various tools or embedded functionality that can allow placement of parts or components from the parts list 503 into the layout representation of the board assembly design 511.

The layout system 530 can initially represent the board assembly design 511 as a blank print circuit board, for example, having dimensions corresponding to one or more of the constraints gleaned from the product model 515. The layout system 530 can receive user input 505, for example, based on the display presentation 542, which can prompt the layout system 530 to perform various updates to the data models corresponding to the board assembly design 511. In some embodiments, the user input 505 can identify a part selected from the parts list 503 and identify a location in the board assembly design 511 for placement of the selected part. The layout system 530 can place at least one component model that corresponds to the selected part in the data model corresponding to the identified location in the board assembly design 511, route traces between the placed parts based on the connectivity in the circuit design 502, or the like.

The electronic design system 500 also can analyze the layout representations for congruency with the design rules. For example, the layout system 530 can perform various design rule checks on the board assembly design 511 to determine whether the updates in the board assembly design 511 violate any design rules or their associated electro-mechanical constraints. The electro-mechanical constraints can include at least one electrical constraint or mechanical constraint for the board assembly design 511. In some embodiments, the layout system 530 can review locations and characteristics of component models placed in the data model of the board assembly design 511 to determine whether the component models, as placed, conform to the design rules. The layout system 530 can provide some granular user options for its design rule checking, for example, allowing user control over which portions of the board assembly design 511 to check for consistency with the design rules. For example, the layout system 530 can compare different portions of the printed circuit board described in the board assembly design 511, such as a printed circuit board assembly, a component on the printed circuit board, a bond wire on the printed circuit board, a particular portion of the printed circuit board itself, such as a board edge, or the like, with each other. The layout system 530 also can compare different portions of the printed circuit board described in the board assembly design 511 with other portions of the product, such as other printed circuit boards in the product, constraints derived or identified from the product model 515, or the like.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
generating, by a computing system, a product model that describes attributes of a product including an electronic system;
determining, by the computing system, one or more sets of metadata capable of being correlated to the electronic system included in the product model based, at least in part, on the attributes of the electronic system described in the product model and metadata populated in previously generated product models describing different electronic systems; and
populating, by the computing system, at least one of the sets of metadata into the product model to correlate with the electronic system.

2. The method of claim 1, wherein the sets of metadata correspond to values for design constraints in the product model associated with electrical connectivity for the electronic system.

3. The method of claim 2, wherein determining the one or more sets of metadata further comprises predicting at least one value for one or more of the design constraints based, at least in part, on one or more of the attributes of the electronic system or other values populated in one or more of the design constraints.

4. The method of claim 3, wherein the populating at least one of the sets of metadata into the product model further comprises automatically populating the product model with one of the sets of the predicted values for the design constraints.

5. The method of claim 2, wherein determining the one or more sets of metadata further comprises identifying which of the design constraints to assign the values based on at least one of the attributes of the electronic system or which of the design constraints had already been populated with one or more of the values.

6. The method of claim 1, further comprising:
comparing, by the computing system, the metadata populated in the product model and the metadata populated in the previously generated product models describing the different electronic systems to identify at least one of differences in design constraints having been populated with values or differences between the values populated in the design constraints; and
utilizing, by the computing system, the identified differences during validation of the metadata populated in the product model.

7. The method of claim 1, wherein the determination of the one or more sets of metadata capable of being correlated to the electronic system included in the product model is performed by a machine-learning algorithm implemented by the computing system having been trained with the metadata populated in the previously generated product models for the different electronic systems.

8. An apparatus comprising at least one computer-readable memory device storing instructions configured to cause one or more processing devices to perform operations comprising:
generating a product model that describes attributes of a product including an electronic system;
determining one or more sets of metadata capable of being correlated to the electronic system included in the product model based, at least in part, on the attributes of the electronic system described in the product model and metadata populated in previously generated product models describing different electronic systems; and
populating at least one of the sets of metadata into the product model to correlate with the electronic system.

9. The apparatus of claim 8, wherein the sets of metadata correspond to values for design constraints in the product model associated with electrical connectivity for the electronic system.

10. The apparatus of claim 9, wherein the instructions configured to cause the one or more processing devices to perform operations further comprising determining the one or more sets of metadata by predicting at least one value for one or more of the design constraints based, at least in part, on one or more of the attributes of the electronic system or other values populated in one or more of the design constraints.

11. The apparatus of claim 10, wherein the instructions configured to cause the one or more processing devices to perform operations further comprising populating at least one of the sets of metadata into the product model by automatically populating the product model with one of the sets of the predicted values for the design constraints.

12. The apparatus of claim 9, wherein the instructions configured to cause the one or more processing devices to perform operations further comprising determining the one or more sets of metadata by identifying which of the design constraints to assign the values based on at least one of the attributes of the electronic system or which of the design constraints had already been populated with one or more of the values.

13. The apparatus of claim 8, wherein the instructions configured to cause the one or more processing devices to perform operations further comprising:
comparing the metadata populated in the product model and the metadata populated in the previously generated product models describing the different electronic systems to identify at least one of differences in design constraints having been populated with values or differences between the values populated in the design constraints; and
utilizing the identified differences during validation of the metadata populated in the product model.

14. The apparatus of claim 8, wherein the determination of the one or more sets of metadata capable of being correlated to the electronic system included in the product model is performed by a machine-learning algorithm implemented by the one or more processing devices having been trained with the metadata populated in the previously generated product models for the different electronic systems.

15. A system comprising:
a memory device configured to store machine-readable instructions; and
a computing system including one or more processing devices, in response to executing the machine-readable instructions, configured to
generate a product model that describes attributes of a product including an electronic system;
determine one or more sets of metadata capable of being correlated to the electronic system included in the product model based, at least in part, on the attributes of the electronic system described in the product model and metadata populated in previously generated product models describing different electronic systems; and
populate at least one of the sets of metadata into the product model to correlate with the electronic system.

16. The system of claim 15, wherein the sets of metadata correspond to values for design constraints in the product model associated with electrical connectivity for the electronic system.

17. The system of claim 16, wherein the one or more processing devices, in response to executing the machine-readable instructions, are configured to determine the one or more sets of metadata by predicting at least one value for one or more of the design constraints based, at least in part, on one or more of the attributes of the electronic system or other values populated in one or more of the design constraints.

18. The system of claim 16, wherein the one or more processing devices, in response to executing the machine-readable instructions, are configured to determine the one or more sets of metadata by identifying which of the design constraints to assign the values based on at least one of the attributes of the electronic system or which of the design constraints had already been populated with one or more of the values.

19. The system of claim 15, wherein the one or more processing devices, in response to executing the machine-readable instructions, are configured to:
compare the metadata populated in the product model and the metadata populated in the previously generated product models describing the different electronic systems to identify at least one of differences in design constraints having been populated with values or differences between the values populated in the design constraints; and
utilize the identified differences during validation of the metadata populated in the product model.

20. The system of claim 15, wherein the one or more processing devices, in response to executing the machine-readable instructions, are configured to determine the one or more sets of metadata capable of being correlated to the electronic system included in the product model is performed by a machine-learning algorithm implemented by the one or more processing devices having been trained with the metadata populated in the previously generated product models for the different electronic systems.
